(19) United States
(12) Patent Application Publication
(10) Pub. No.: US 2023/0376657 A1
(43) Pub. Date: Nov. 23, 2023

(54) EVALUATION METHOD FOR ACID FRACTURING EFFECT BASED ON THE THEORY OF ACID-FRAC "STIMULATED ZONE"

(71) Applicant: Southwest Petroleum University, Chengdu (CN)

(72) Inventors: Yu PENG, Chengdu (CN); Pengjun SHI, Chengdu (CN); Yongming LI, Chengdu (CN); Weihua CHEN, Chengdu (CN); Fei LIU, Chengdu (CN); Ji ZENG, Chengdu (CN)

(73) Assignee: Southwest Petroleum University, Chengdu (CN)

(21) Appl. No.: 18/153,018

(22) Filed: Jan. 11, 2023

(30) Foreign Application Priority Data
May 18, 2022 (CN) 202210537578.5

(51) Int. Cl. G06F 30/28

(52) U.S. Cl. CPC G06F 30/28; G06F 2111/10

(57) ABSTRACT

The present invention discloses an evaluation method for acid fracturing effect based on the theory of acid-frac “stimulated zone”, comprising the following steps: establish a structured reservoir grid, and add initial artificial fractures to the structured reservoir grid; establish a fracture propagation model considering the acid-frac stimulated zone, on the basis of the structured reservoir grid, conduct numerical simulation according to the fracture propagation model, and work out the seepage parameters during acid fracturing; establish a gas well production model, and calculate the pore distribution and liquid saturation distribution of the reservoir in gas well production; calculate the cumulative production of the gas well, and calculate the multiple proportion of cumulative production increase of the construction plan according to the cumulative production of the gas well; the greater the multiple proportion, the better the acid fracturing effect.

### CROSS-REFERENCE TO RELATED APPLICATIONS

The application claims priority to Chinese patent application No. 202210537578.5, filed on May 18, 2022, the entire contents of which are incorporated herein by reference.

### TECHNICAL FIELD

The present invention relates to the technical field of oil and gas field development, in particular to an evaluation method for acid fracturing effect based on the theory of acid-frac “stimulated zone”.

### BACKGROUND

Acidification is to filter acid fluid into reservoir matrix and dissolve minerals so as to improve matrix permeability, thus forming a stimulated zone near the wellbore. Acid fracturing is to break rock by hydraulic pressure and heterogeneously etch the wall of artificial fractures so as to form acid etched fractures with flow conductivity after fluid flowback and fracture closure to increase production. For far too long, when evaluating the acid fracturing effect, petroleum engineers mainly focus on the stimulation effect of acid etched fractures on oil wells and gas wells. They usually improved the credibility of the evaluation on improving the acid fracturing effect in reservoirs by considering the effect of acid etched fractures on fracture conductivity, fracture morphology and effective fracture length, while ignoring the stimulated zone formed by the dissolution of acid fluid filtering along the acid etched fractures in the reservoir matrix and the seepage pattern improvement and stimulation inside this stimulated zone. Therefore, the simulated acid fracturing effect is different from the actual acid fracturing effect, which cannot accurately reflect the actual acid fracturing effect of the construction plan.

### SUMMARY

To address the above problems, the present invention aims to provide an evaluation method for acid fracturing effect based on the theory of acid-frac “stimulated zone”, which additionally considers the improvement of the seepage pattern in the “stimulated zone” near the acid etched fractures, and evaluates the acid fracturing effect by predicting the changes in porosity and permeability of the reservoir during stimulation stage and production stage and the cumulative gas production during a certain production period.

The technical solution of the present invention is as follows:

An evaluation method for acid fracturing effect based on the theory of acid-frac “stimulated zone”, comprising the following steps:
Step 1: Establishing a structured reservoir grid, and adding initial artificial fractures to the structured reservoir grid, wherein the initial artificial fractures are divided into multiple fracture units by the structured reservoir grid, the fracture units are numbered L=1, 2, 3, . . . , the length of each fracture unit is denoted as ξ_{L} and the total number of fracture units as n_{f};
Step 2: Establishing a fracture propagation model considering the acid-frac stimulated zone;
Step 3: On the basis of the structured reservoir grid, conducting numerical simulation according to the fracture propagation model, and working out the seepage parameters at a certain moment during acid fracturing;
Step 4: Determining whether the fracture propagates at a given time according to the acid etched fracture propagation criterion: if there is no propagation, the total number n_{f} of fracture units remains unchanged; if there is propagation, the total number of fracture units is n_{f}=n_{f}+1;
Step 5: Taking the seepage parameters obtained in Step 3 and the total number of fracture units obtained in Step 4 as the initial conditions for the next time, and repeating Steps 3 to 5 until the completion of acid fracturing to obtain the seepage parameters at the end of acid fracturing;
Step 6: Establishing a gas well production model, and calculating the pore distribution and liquid saturation distribution of the reservoir in gas well production according to the gas well production model;
Step 7: Calculating the cumulative production of the gas well according to the results obtained in Steps 5 and 6;
Step 8: Calculating the multiple proportion of cumulative production increase of the construction plan according to the cumulative production of the gas well; the greater the multiple proportion, the better the acid fracturing effect.

Preferably, in Step 1, the establishment of the structured reservoir grid comprises the following sub-steps: collecting the geological exploration data of target reservoir, dividing the reservoir length Lₓ and width L_{y} into nᵢ and nⱼ segments respectively in a x-y rectangular coordinate system, so the entire reservoir can be divided into a nᵢ×nⱼ structured grid, where x_{i,j} and y_{i,j} represent the length and width of each grid respectively, and the subscripts i and j represent the position of each grid in the reservoir.

Preferably, in Step 1, when adding initial artificial fractures to the structured reservoir grid, the propagation direction of initial artificial fracture is designed as the x-axis direction and the propagation length as the total length of N grids, and the N is an integer greater than or equal to 3.

Preferably, in Step 2, the fracture propagation model includes:

(1) Calculation model considering fracture width and intra-fracture pressure in the acid-frac stimulated zone:

$$W ( x , t ) = w ( x ) + \overline{{w}_{e} ( t )} \qquad ( 1 )$$

$$\frac{π E}{512 μ ( 1 - {ν}^{2} )} \frac{{\partial }^{2} {w}^{4} ( x )}{{u}^{2}} - 2 {v}_{l} H = \frac{π H}{4} \frac{\partial w ( x )}{\partial t} \qquad ( 2 )$$

$${v}_{l} = \frac{{k}_{m f}}{μ \overline{d}} [ \frac{w ( x ) E}{2 ( 1 - {ν}^{2} ) H} + {σ}_{n} - {P}_{m} ( x ) ] \qquad ( 3 )$$

$$\frac{β}{{ρ}_{r} ( 1 - {ϕ}_{m} )} ( 2 η {v}_{l} {C}_{f} + 2 {k}_{c} {C}_{f} ) = \frac{\partial \overline{{w}_{e} ( t )}}{\partial t} \qquad ( 4 )$$

$${P}_{f} ( x , t ) = \frac{W ( x , t ) E}{2 ( 1 - {ν}^{2} ) H} + {σ}_{n} \qquad ( 5 )$$

Where, W(x,t)—Width of the acid etched fracture at any time and at any position during acid fracturing, in m; w(x)—Width of acid etched fracture, in m; w̅ₑ̅(̅t̅)̅—Average width of acid etched fracture at acid fracturing time, in m; E—Young's modulus of reservoir rock sample, in MPa; μ—Viscosity of acidizing fluid, in mPa·s; v—Poisson's ratio of reservoir rock sample; x—Position of the structured reservoir grid along the X axis; vₗ—Filtration rate of acidizing fluid, in m/s; H—Height of acid etched fracture, in m; t—Acid fracturing time, in s; k_{mf}—Average permeability between acid etched fracture and surrounding matrix, in mD; d̅—Distance from the acid etched fracture to the center point of the matrix grid where it is located, in m; σₙ—Minimum horizontal principal stress, in MPa; Pₘ(x)—Fluid pressure of the matrix around acid etched fracture, in MPa; β—Rock dissolution capacity of acidizing fluid, defined as the mass of rock dissolved by acidizing fluid per mole, in kg/mol; ρᵣ—Rock density, in kg/m³; ϕₘ—Porosity of reservoir matrix, in %; η—Mass fraction of acidizing fluid in filtration that is involved in etching fracture wall; C_{f}—Acidizing fluid concentration in the fracture, in mol/m³; k_{c}—Mass transfer coefficient, in m/s; P_{f}(x,t)—Fluid pressure in the acid etched fracture at any time and at any position in the fracturing process, in MPa.

(2) Matrix seepage model considering acid-frac stimulated zone during acid fracturing of gas reservoir:

$$\frac{\partial }{\partial x} ( κ \frac{{k}_{fw}}{μ B} \frac{\partial {P}_{f} ( x , t )}{\partial x} ) - {δ}_{m} \frac{{v}_{l} {A}_{m f}}{{V}_{f}} = \frac{\partial }{\partial t} ( \frac{{ϕ}_{f}}{B} ) \qquad ( 6 )$$

$$\frac{\partial }{\partial x} ( \frac{{k}_{m} {k}_{mrw}}{{μ}_{w} {B}_{w}} \frac{\partial {P}_{mw}}{\partial x} ) + \frac{\partial }{\partial y} ( \frac{{k}_{m} {k}_{mrw}}{{μ}_{w} {B}_{w}} \frac{\partial {P}_{mw}}{\partial y} ) + {δ}_{m} \frac{{v}_{l} {A}_{m f}}{{V}_{b}} = \frac{\partial }{\partial t} ( \frac{{ϕ}_{m} {S}_{mw}}{{B}_{w}} ) \qquad ( 7 )$$

$$\frac{\partial }{\partial x} ( \frac{{k}_{m} {k}_{m r g}}{{μ}_{g} {B}_{g}} \frac{\partial {P}_{m g}}{\partial x} ) + \frac{\partial }{\partial y} ( \frac{{k}_{m} {k}_{m r g}}{{μ}_{g} {B}_{g}} \frac{\partial {P}_{m g}}{\partial y} ) = \frac{\partial }{\partial t} ( \frac{{ϕ}_{m} ( 1 - {S}_{m w} )}{{B}_{g}} ) \qquad ( 8 )$$

$${P}_{m c} = {P}_{m g} - {P}_{m ν} \qquad ( 9 )$$

Where, κ—Unit conversion coefficient, in 10⁻³; k_{fw}—Effective liquid permeability of acid etched fracture, in mD; B—Volume coefficient of acidizing fluid; δₘ—Judgment parameter, specifically δₘ=1 if there is fractures across the reservoir matrix grid and δₘ=0 if there is no fracture across the reservoir matrix grid; A_{mf}—Contact area between fracture and matrix, in m²; V_{f}—Volume of acid etched fracture unit, in m³; ϕ_{f}—Porosity of acid etched fracture; km Reservoir matrix permeability, in mD; kₘᵣ—Relative liquid permeability of the reservoir matrix; k_{mrg}—Relative gas permeability of the reservoir matrix; w Liquid viscosity in the reservoir matrix, in mPa·s; μ_{g}—Gas viscosity in the reservoir matrix, in mPa·s; B_{w}—Bolume coefficient of liquid in the reservoir matrix; B_{g}—Volume coefficient of gas in the reservoir matrix; P_{mw}, P_{mg}—Liquid pressure and gas pressure in the reservoir matrix, in MPa; y—Position of the structured reservoir grid along the Y axis; V_{b}—Volume of reservoir matrix unit, in m³; S_{mw}—Liquid saturation in the reservoir matrix; P_{mc}—Capillary pressure in the reservoir matrix, in MPa.

The calculation model of acidizing fluid concentration distribution in reservoir matrix grid is as follows:

$$\frac{\partial }{\partial t} ( {ϕ}_{m} {C}_{m} ) = [ \begin{matrix}- \frac{\partial }{\partial x} ( {C}_{m} \frac{{k}_{m} {k}_{m r w}}{{μ}_{w}} \frac{\partial {P}_{m w}}{\partial x} ) - \frac{\partial }{\partial y} ( {C}_{m} \frac{{k}_{m} {k}_{m r w}}{{μ}_{w}} \frac{\partial {P}_{m w}}{\partial y} ) \\ + \frac{\partial }{\partial x} ( {ϕ}_{m} {D}_{ex} \frac{\partial {C}_{m}}{\partial x} ) + \frac{\partial }{\partial y} ( {ϕ}_{m} {D}_{ey} \frac{\partial {C}_{m}}{\partial y} ) \\ + {δ}_{m} \frac{{v}_{l} {A}_{m f} {C}_{f}}{{V}_{b}} - {k}_{s} {C}_{s} {a}_{v}\end{matrix} ] \qquad ( 10 )$$

$${C}_{s} = \frac{{C}_{m}}{1 + \frac{{k}_{s}}{{k}_{c}}} \qquad ( 11 )$$

$${D}_{e i} = {α}_{o s} {D}_{m} + {λ}_{i} \vert {v}_{l} \vert {d}_{h} \qquad ( 12 )$$

Where, Cₘ—Acidizing fluid concentration in matrix pores, in mol/m³; Dₑₓ—Effective diffusion tensor in the x direction, in m²/s; D_{ey}—Effective diffusion tensor in the y direction, in m²/s; kₛ—Reaction velocity constant, in m/s; Cₛ—Acidizing fluid concentration at the pore wall, in mol/m³; aᵥ—Rock specific surface area of reservoir matrix, in m²/m³; Dₑᵢ—Effective diffusion tensor in the i direction, in m²/s; αₒₛ, λᵢ—Pore structure constant, and αₒₛ=1, λₓ≈0.5 and λy≤1 for spherical filling medium; Dₘ—Molecular diffusion coefficient, in m²/s; dₕ—Hydraulic diameter of tubular pore, in m.

The calculation model of matrix porosity and permeability changes during acid-rock reaction is as follows:

$$\frac{\partial {ϕ}_{m}}{\partial t} = \frac{{k}_{s} {C}_{s} β {a}_{v}}{{ρ}_{r}} \qquad ( 13 )$$

$$\frac{{k}_{m}}{{k}_{m 0}} = \frac{{ϕ}_{m}}{{ϕ}_{m 0}} {( \frac{{ϕ}_{m} ( 1 - {ϕ}_{m 0} )}{{ϕ}_{m 0} ( 1 - {ϕ}_{m} )} )}^{2 γ} \qquad ( 14 )$$

$$\frac{{a}_{v}}{{a}_{v 0}} = \frac{{ϕ}_{m}}{{{ϕ}_{m 0} ( \frac{{k}_{m} {ϕ}_{m 0}}{{k}_{m 0} {ϕ}_{m}} )}^{1 / 2}} \qquad ( 15 )$$

Where, kₘ₀—Initial permeability of reservoir matrix, in mD; ϕₘ₀—Initial porosity of reservoir matrix; γ—Parameter related to pore structure; aᵥ₀—Initial rock specific surface area of reservoir matrix, in m²/m³.

(3) Initial conditions for gas reservoir seepage:

Pmg(i,j,t)|ₜ₌₀=P₀ (16)

Where, P_{mg}(i,j,t)—Gas pressure in the reservoir matrix at the coordinates of positions i and j in the grid at time t, in MPa; P₀—Original formation pressure of gas reservoir, in MPa.

(4) Boundary conditions for fracture propagation:

$$\{ \begin{matrix}W ( x , t ) = 0 & x > {x}_{L = 1} + {\sum }_{L = 1}^{{n}_{f , t}} {ξ}_{L} Or x < {x}_{L = 1} \\ \frac{{\partial }^{2} {W ( x , t )}^{4}}{\partial x} = \frac{256 {Q}_{int} μ ( 1 - v )}{π G} & x = 0\end{matrix} \qquad ( 17 )$$

$${P}_{fL = 1 , t} = {P}_{i n t} \qquad ( 18 )$$

Where, Qᵢₙₜ—Injection displacement of acid fracturing, in m³/min; G—Volume modulus of reservoir rock sample, in MPa; x_{L=1}—Rectangular coordinates of the first acid etched fracture unit; n_{f,t}—Total number of acid etched fracture units at time t; ξ_{L}—length of the L^{th} acid etched fracture unit, in m; P_{fL=1,t}—Fluid pressure in the acid etched fracture unit in Section 1 at time t, in MPa; Pᵢₙₜ—Downhole pressure during acid fracturing, in MPa.

(5) Boundary conditions for gas reservoir matrix seepage:

$$\{ \begin{matrix}\frac{\partial {P}_{mg}}{\partial x} {\vert}_{x = 0 , {L}_{x}} = 0 \\ \frac{\partial {P}_{mg}}{\partial y} {\vert}_{y = 0 , {L}_{y}} = 0\end{matrix} \& \{ \begin{matrix}\frac{\partial {P}_{mw}}{\partial x} {\vert}_{x = 0 , {L}_{x}} = 0 \\ \frac{\partial {P}_{mw}}{\partial y} {\vert}_{y = 0 , {L}_{y}} = 0\end{matrix} \qquad ( 19 )$$

Where, Lₓ, L_{y}—Length and width of reservoir, in m;

(6) Boundary conditions and initial conditions for acidizing fluid migration reaction model:

$$\{ \begin{matrix}{C}_{f} ( 0 , t ) = {C}_{0 , t} \\ \begin{matrix}{C}_{f} ( {x}_{L} , t ) = {C}_{0 , t} & 0 < {x}_{L} < {L}_{f}\end{matrix} \\ {C}_{f} ( {L}_{f} , t ) = 0 \\ {C}_{m , t = 0} = 0 \\ {C}_{s , t = 0} = 0\end{matrix} \qquad ( 20 )$$

Where, C_{f}(0,t)—Acidizing fluid concentration in initial artificial fracture unit at the acid fracturing time t, in mol/m³; C_{f}(x_{L},t)—Acidizing fluid concentration in artificial fracture unit corresponding to the horizontal coordinate x_{L} at time t, in mol/m³; C_{f}(L_{f},t)—Acidizing fluid concentration at the artificial fracture tip at time t, in mol/m³; C_{m,t=0}—Acidizing fluid concentration in the pore at the initial acid fracturing time, in mol/m³; C_{s,t=0}—Acidizing fluid concentration at the pore wall at the initial acid fracturing time, in mol/m³; L_{f}—Horizontal coordinate corresponding to the tip of artificial fracture unit at time t; C_{0,t}—Acidizing fluid concentration of construction fluid at time t, in mol/m³.

Preferably, in Step 4, the below is the criterion for determining acid etched fracture propagation:
When the stress intensity factor K_{If,t} at fracture tip is less than or equal to the fracture toughness K_{IC} of reservoir rock, the fracture will propagate;
When the stress intensity factor K_{If,t} at fracture tip is greater than the fracture toughness K_{IC} of reservoir rock, the fracture will not propagate.

Preferably, the stress intensity factor K_{If,t} at fracture tip is calculated by the following equation:

$${K}_{If , t} = \frac{0.806 E \sqrt{π} {W}_{L = {n}_{f} , t}}{4 ( 1 - {v}^{2} ) \sqrt{2 Δ x}} \qquad ( 21 )$$

Where, K_{If,t}—Stress intensity factor at fracture tip at time t, in MPa·m¹²; E—Young's modulus of reservoir rock sample, in MPa; W_{L=n,t}—Average width of structured reservoir grid, in m; v—Poisson's ratio of reservoir rock sample; Δx—Width of artificial fracture tip at time t, in m.

The fracture toughness K_{IC} of reservoir rock is calculated by the following equation:

$${K}_{I C} = 0.3172 {ρ}_{r} + \frac{0.0457}{{V}_{c}} + 0.2 \; 131 ln ( DT ) \times 0.5041 \qquad ( 22 )$$

Where, K_{IC}—Type I fracture toughness of reservoir rock, in MPa·m^{1/2}; ρᵣ—Rock density, in kg/m³; V_{c}—Average shaliness of reservoir rocks, in %; DT—Average interval transit time of the reservoir, in μs/m.

Preferably, in Step 6, the gas well production model includes:

(1) Differential equation of gas-water seepage in gas reservoir:

$$\frac{\partial }{\partial x} ( κ \frac{{k}_{f} {k}_{frw}}{{μ}_{w} {B}_{w}} \frac{\partial {P}_{f}}{\partial x} ) + \frac{{q}_{fw}}{{V}_{f}} + {δ}_{m} \frac{{Q}_{mw}}{{V}_{f}} = \frac{\partial }{\partial {t}_{p}} ( \frac{{ϕ}_{f} {S}_{fw}}{{B}_{w}} ) \qquad ( 23 )$$

$$\frac{\partial }{\partial x} ( κ \frac{{k}_{f} {k}_{frg}}{{μ}_{g} {B}_{g}} \frac{\partial {P}_{f}}{\partial x} ) + \frac{{q}_{f g}}{{V}_{f}} + {δ}_{m} \frac{{Q}_{m g}}{{V}_{f}} = \frac{\partial }{\partial {t}_{p}} ( \frac{{ϕ}_{f} ( 1 - {S}_{fw} )}{{B}_{g}} ) \qquad ( 24 )$$

$$∇ ( β \frac{{k}_{m} {k}_{m r w}}{{μ}_{w} {B}_{w}} ∇ {P}_{m w} ) - {δ}_{m} \frac{{Q}_{m w}}{{V}_{b}} = \frac{\partial }{\partial {t}_{p}} ( \frac{{ϕ}_{m} {S}_{m w}}{{B}_{w}} ) \qquad ( 25 )$$

$$∇ ( β \frac{{k}_{m} {k}_{m r g}}{{μ}_{g} {B}_{g}} ∇ {P}_{m g} ) - {δ}_{m} \frac{{Q}_{m g}}{{V}_{b}} = \frac{\partial }{\partial {t}_{p}} ( \frac{{ϕ}_{m} ( 1 - {S}_{m w} )}{{B}_{g}} ) \qquad ( 26 )$$

$${Q}_{m w} = \frac{2 {k}_{m} {k}_{m w} \cdot {ξ}_{L} H}{{μ}_{w} \overline{d}} ( {P}_{m w} - {P}_{f} ) \qquad ( 27 )$$

$${Q}_{m g} = \frac{2 {k}_{m} {k}_{m g} \cdot {ξ}_{L} H}{{μ}_{g} \overline{d}} ( {P}_{m g} - {P}_{f} ) \qquad ( 28 )$$

Where, k_{f}—Permeability of acid etched fracture, in mD; k_{frw}, k_{frg}—Relative permeability of liquid and gas in acid etched fracture; P_{f}—Pressure in artificial fracture, in MPa; q_{fw}, q_{fg}—Source and sink terms of liquid and gas in acid etched fracture, in m³/s; Q_{mw}, Q_{mg}—Liquid flow and gas flow between the main fracture and the matrix during gas well production, in m³/s; S_{fw}—Liquid saturation in acid etched fracture; tₚ—Production time of gas well, in s; ∇—Gradient operator.

(2) Initial conditions:

Initial pressure distribution:

$$\{ \begin{matrix}{P}_{fgL , {t}_{p} = 0} = {P}_{fwL , {t}_{p} = 0} = {P}_{fL , {t}_{p} = 0} = {P}_{f L , {t}_{e n d}} \\ {P}_{m g} ( i , j , {t}_{p} ) {\vert}_{{t}_{p} = 0} = {P}_{m g} ( i , j , t ) {\vert}_{t = {t}_{e n d}} \\ {P}_{m w} ( i , j , {t}_{p} ) {\vert}_{{t}_{p} = 0} = {P}_{m w} ( i , j , t ) {\vert}_{t = {t}_{e n d}}\end{matrix} \qquad ( 29 )$$

Where, P_{fg L,p=0}—Initial gas pressure distribution of acid etched fracture in gas well production simulation, in MPa; P_{fw L,tp=0}—Initial liquid pressure distribution of acid etched fracture in gas well production simulation, in MPa; P_{fL,tp=0}—Initial pressure distribution of acid etched fracture in gas well production simulation, in MPa; P_{fL,tend}—Pressure distribution of artificial fracture at the end of acid fracturing, in MPa; P_{mg}(i,j,tₚ)|ₜₚ₌₀—Initial gas pressure distribution of reservoir matrix in gas well production simulation, in MPa; P_{mg}(i,j,t)|_{t=tend}—Pressure distribution in artificial fracture at the end of acid fracturing, in MPa; P_{mw}(i,j,tp)|ₜₚ₌₀—Initial liquid pressure distribution of reservoir matrix in gas well production simulation, in MPa; P_{mw}(i,j,t)|_{t-tend}—Liquid pressure distribution in artificial fracture at the end of acid fracturing, in MPa.

Initial saturation distribution:

$$\{ \begin{matrix}{S}_{fw} ( L , {t}_{p} ) {\vert}_{{t}_{p} = 0} = 1 \\ {S}_{m w} ( i , j , {t}_{p} ) {\vert}_{{t}_{p} = 0} = {S}_{m w} ( i , j , t ) {\vert}_{t = {t}_{e n d}}\end{matrix} \qquad ( 30 )$$

Where, S_{fw}(L,tₚ)|ₜₚ₌₀—Initial liquid saturation of acid etched fracture in gas well production simulation; S_{mw}(i,j,tp)|ₜₚ₌₀—Initial liquid saturation of reservoir matrix in gas well production simulation; S_{mw}(i,j,t)|_{t=tend}—Liquid saturation of reservoir matrix at the end of acid fracturing.

(3) Internal boundary conditions:

P_{w}(x_{w},y_{w},tₚ)=P_{wf}(tₚ) (31)

Where, P_{w}(x_{w}, y_{w}, tₚ)—Liquid pressure of well-corresponding grid at the simulated time tₚ of gas well production, in MPa; P_{wf}(tₚ)—Bottom hole flowing pressure at production time tₚ, in MPa;

(4) External boundary conditions:

$$\{ \begin{matrix}\frac{\partial {P}_{m w} ( i , j , {t}_{p} )}{\partial x} {\vert}_{x = 0 , {L}_{x}} = 0 \\ \frac{\partial {P}_{m g} ( i , j , {t}_{p} )}{\partial y} {\vert}_{y = 0 , {L}_{y}} = 0\end{matrix} \& \{ \begin{matrix}\frac{\partial {P}_{m w} ( i , j , {t}_{p} )}{\partial x} {\vert}_{x = 0 , {L}_{x}} = 0 \\ \frac{\partial {P}_{mw} ( i , j , {t}_{p} )}{\partial y} {\vert}_{y = 0 , {L}_{y}} = 0\end{matrix} . \qquad ( 32 )$$

Preferably, in Step 7, the cumulative production of the gas well is calculated by the following equation:

$$Q = {\sum }_{i = 1}^{{n}_{i}} {\sum }_{j = 1}^{{n}_{j}} ( {x}_{i , j} \cdot {y}_{i , j} \cdot H ) ( {ϕ}_{m} ( i , j , {t}_{p} ) \cdot {S}_{mw} ( i , j , {t}_{p} ) - {ϕ}_{m} ( i , j , {t}_{e n d} ) {S}_{mw} ( i , j , {t}_{e n d} ) ) + {\sum }_{L = 1}^{{n}_{f , {t}_{end}}} ( {ξ}_{L} \cdot {W}_{L , {t}_{e n d}} \cdot H ) ( {ϕ}_{f} ( L , {t}_{e n d} ) {S}_{fw} ( L , {t}_{e n d} ) - {ϕ}_{f} ( L , {t}_{p} ) {S}_{f w} ( L , {t}_{p} ) ) \qquad ( 33 )$$

Where, Q—Cumulative production of gas well at time tₚ, in m³; nᵢ, nⱼ—Total number of grids in x and y directions in the structured reservoir grid; x_{i,j}, y_{i,j}—Length and width of matrix grid at positions i and j, in m; ϕₘ(i,j,tₚ)—Porosity of matrix grid at positions i and j at time tₚ; S_{mw}(i,j,tₚ) Liquid saturation of matrix grid at positions i and j at time tₚ; ϕₘ(i,j,t_{end})—Porosity of matrix grid at positions i and j at time tₚ; S_{mw}(i,j,t_{end})—Liquid saturation of matrix grid at positions i and j at time tₚ; n_{f,tend}—Total number of acid etched fracture units at time t_{end}; W_{L,tend}—Width of acid etched fracture unit in Section L at time t_{end}, in m; ϕ^{f}(i,j,t_{end})—Porosity of acid etched fracture unit in Section L at time t_{end}; S_{fw}(L,t_{end})—Liquid saturation of acid etched fracture unit in Section L at time t_{end}; ϕ^{f}(L,tₚ)—Porosity of acid etched fracture unit in Section L at time tₚ; S_{fw}(L,tₚ)—Liquid saturation of acid etched fracture unit in Section L at time tₚ.

In Step 8, the multiple proportion of cumulative production increase is calculated by the following equation:

$$S = \frac{{Q}_{T}}{{Q}_{0 , T}} \qquad ( 34 )$$

Where, S—Multiple proportion of cumulative production increase; Q_{T}—Simulated cumulative production of the gas well at time T after acid fracturing, in m³; T—Time when the daily gas production after acid fracturing is equal to the daily gas production before acid fracturing, in d; Q_{0,T}—Estimated cumulative production of the gas well at T without acid-fracturing stimulation, in m³.

The present invention has the following beneficial effects:

In the present invention, structured grid and embedded discrete fracture model are used to simulate acid etched fracture propagation, stimulated zone formation and matrix seepage in stimulated zone during production, which not only significantly improves the computational efficiency of the model, but also effectively improves the evaluation accuracy of acid fracturing effect, so that the carbonate reservoir can be developed with reduced cost and enhanced efficiency.

### BRIEF DESCRIPTION OF DRAWINGS

In order to explain the embodiments of the present invention or the technical solutions in the prior art more clearly, the following will make a brief introduction to the drawings needed in the description of the embodiments or the prior art. Obviously, the drawings in the following description are merely some embodiments of the present invention. For those of ordinary skill in the art, other drawings can be obtained based on the structures shown in these drawings without any creative effort.

FIG. 1 is a schematic diagram of deep acid-fracturing stimulation of carbonate reservoir in a specific embodiment;

FIG. 2 is the comparison results of simulated and actual cumulative productions of Well X in a specific embodiment.

### DETAILED DESCRIPTION OF THE EMBODIMENTS

The present invention is further described with reference to the drawings and embodiments.

It should be noted that the embodiments in this application and the technical features in the embodiments can be combined with each other without conflict. It is to be noted that, unless otherwise specified, all technical and scientific terms herein have the same meaning as commonly understood by those of ordinary skill in the art to which this application belongs. “Include” or “comprise” and other similar words used in the present disclosure mean that the components or objects before the word cover the components or objects listed after the word and its equivalents, but do not exclude other components or objects.

The present invention provides an evaluation method for acid fracturing effect based on the theory of acid-frac “stimulated zone”, comprising the following steps.

Step 1: Establishing a structured reservoir grid, and adding initial artificial fractures to the structured reservoir grid, wherein the initial artificial fractures are divided into multiple fracture units by the structured reservoir grid, the fracture units are numbered L=1, 2, 3, . . . , the length of each fracture unit is denoted as ξ_{L} and the total number of fracture units as n_{f};

In a specific embodiment, the establishment of a structured reservoir grid includes the following sub-steps: collecting the geological exploration data of target reservoir, dividing the reservoir length Lₓ and width L_{y} into nᵢ and nⱼ segments respectively in a x-y rectangular coordinate system, so the entire reservoir can be divided into a nᵢ×nⱼ structured grid. where x_{i,j} and y_{i,j} represent the length and width of each grid respectively, and the subscripts i and j represent the position of each grid in the reservoir. When adding initial artificial fractures to the structured reservoir grid, the propagation direction of initial artificial fracture is designed as the x-axis direction and the propagation length as the total length of N grids, and the N is an integer greater than or equal to 3.

Step 2: Establishing a fracture propagation model considering the acid-frac stimulated zone, wherein the fracture propagation model includes:

(1) Calculation model considering fracture width and intra-fracture pressure in the acid-frac stimulated zone:

$$W ( x , t ) = w ( x ) + \overline{{w}_{e} ( t )} \qquad ( 1 )$$

$$\frac{π E}{512 μ ( 1 - {v}^{2} )} \frac{{\partial }^{2} {w}^{4} ( x )}{\partial {x}^{2}} - 2 {v}_{l} H = \frac{π H}{4} \frac{\partial w ( x )}{\partial t} \qquad ( 2 )$$

$${v}_{l} = \frac{{k}_{m f}}{μ \overline{d}} [ \frac{w ( x ) E}{2 ( 1 - {𝓋}^{2} ) H} + {σ}_{n} - {P}_{m} ( x ) ] \qquad ( 3 )$$

$$\frac{β}{{ρ}_{r} ( 1 - {ϕ}_{m} )} ( 2 η {v}_{l} {C}_{f} + 2 {k}_{c} {C}_{f} ) = \frac{\partial \overline{{w}_{e} ( t )}}{\partial t} \qquad ( 4 )$$

$${P}_{f} ( x , t ) = \frac{W ( x , t ) E}{2 ( 1 - {v}^{2} ) H} + {σ}_{n} \qquad ( 5 )$$

Where, W(x,t)—Width of the acid etched fracture at any time and at any position during acid fracturing, in m; w(x)—Width of acid etched fracture, in m; w̅ₑ̅(̅t̅)̅—Average width of acid etched fracture at acid fracturing time, in m; E—Young's modulus of reservoir rock sample, in MPa; μ—Viscosity of acidizing fluid, in mPa·s; v—Poisson's ratio of reservoir rock sample; x—Position of the structured reservoir grid along the X axis; vₗ—Filtration rate of acidizing fluid, in m/s; H—Height of acid etched fracture, in m; t—Acid fracturing time, in s; k_{mf}—Average permeability between acid etched fracture and surrounding matrix, in mD; d̅—Distance from the acid etched fracture to the center point of the matrix grid where it is located, in m; σₙ—Minimum horizontal principal stress, in MPa; Pₘ(x)—Fluid pressure of the matrix around acid etched fracture, in MPa; β—Rock dissolution capacity of acidizing fluid, defined as the mass of rock dissolved by acidizing fluid per mole, in kg/mol; ρᵣ—Rock density, in kg/m³; ϕₘ—Porosity of reservoir matrix, in %; η—Mass fraction of acidizing fluid in filtration that is involved in etching fracture wall; C_{f}—Acidizing fluid concentration in the fracture, in mol/m³; kₑ—Mass transfer coefficient, in m/s; P_{f}(x,t)—Fluid pressure in the acid etched fracture at any time and at any position in the fracturing process, in MPa.

(2) Matrix seepage model considering acid-frac stimulated zone during acid fracturing of gas reservoir:

$$\frac{\partial }{\partial x} ( κ \frac{{k}_{fw}}{μ B} \frac{\partial {P}_{f} ( x , t )}{\partial x} ) - {δ}_{m} \frac{{v}_{l} {A}_{m f}}{{V}_{f}} = \frac{\partial }{\partial t} ( \frac{{ϕ}_{f}}{B} ) \qquad ( 6 )$$

$$\frac{\partial }{\partial x} ( \frac{{k}_{m} {k}_{m r w}}{{μ}_{w} {B}_{w}} \frac{\partial {P}_{m w}}{\partial x} ) + \frac{\partial }{\partial y} ( \frac{{k}_{m} {k}_{m r w}}{{μ}_{w} {B}_{w}} \frac{\partial {P}_{m w}}{\partial y} ) + {δ}_{m} \frac{{v}_{l} {A}_{m f}}{{V}_{b}} = \frac{\partial }{\partial t} ( \frac{{ϕ}_{m} {S}_{m w}}{{B}_{w}} ) \qquad ( 7 )$$

$$\frac{\partial }{\partial x} ( \frac{{k}_{m} {k}_{m r g}}{{μ}_{g} {B}_{g}} \frac{\partial {P}_{m g}}{\partial x} ) + \frac{\partial }{\partial y} ( \frac{{k}_{m} {k}_{m r g}}{{μ}_{g} {B}_{g}} \frac{\partial {P}_{m g}}{\partial y} ) = \frac{\partial }{\partial t} ( \frac{{ϕ}_{m} ( 1 - {S}_{m w} )}{{B}_{g}} ) \qquad ( 8 )$$

$${P}_{m c} = {P}_{m g} - {P}_{mv} \qquad ( 9 )$$

Where, κ—Unit conversion coefficient, in 10⁻³; k_{fw}—Effective liquid permeability of acid etched fracture, in mD; B—Volume coefficient of acidizing fluid; δₘ—Judgment parameter, specifically δₘ=1 if there is fractures across the reservoir matrix grid and δₘ=0 if there is no fracture across the reservoir matrix grid; A_{mf}—Contact area between fracture and matrix, in m²; V_{f}—Volume of acid etched fracture unit, in m³; ϕ_{f}—Porosity of acid etched fracture; kₘ—Reservoir matrix permeability, in mD; k_{mrw}—Relative liquid permeability of the reservoir matrix; k_{mrg}—Relative gas permeability of the reservoir matrix; μ_{w}—Liquid viscosity in the reservoir matrix, in mPa·s; μ_{g}—Gas viscosity in the reservoir matrix, in mPa·s; B_{w}—Bolume coefficient of liquid in the reservoir matrix; B_{g}—Volume coefficient of gas in the reservoir matrix; P_{mw}, P_{mg}—Liquid pressure and gas pressure in the reservoir matrix, in MPa; y—Position of the structured reservoir grid along the Y axis; V_{b}Volume of reservoir matrix unit, in m³; S_{mw}—Liquid saturation in the reservoir matrix; P_{mc}—Capillary pressure in the reservoir matrix, in MPa.

The calculation model of acidizing fluid concentration distribution in reservoir matrix grid is as follows:

$$\frac{\partial }{\partial t} ( {ϕ}_{m} {C}_{m} ) = [ \begin{matrix}- \frac{\partial }{\partial x} ( {C}_{m} \frac{{k}_{m} {k}_{mrw}}{{μ}_{w}} \frac{\partial {P}_{mw}}{\partial x} ) - \frac{\partial }{\partial y} ( {C}_{m} \frac{{k}_{m} {k}_{mrw}}{{μ}_{w}} \frac{\partial {P}_{mw}}{\partial y} ) + \\ \frac{\partial }{\partial x} ( {ϕ}_{m} {D}_{ex} \frac{\partial {C}_{m}}{\partial x} ) + \frac{\partial }{\partial y} ( {ϕ}_{m} {D}_{ey} \frac{\partial {C}_{m}}{\partial y} ) + \\ {δ}_{m} \frac{{v}_{l} {A}_{mf} {C}_{f}}{{V}_{b}} - {k}_{s} {C}_{s} {a}_{v}\end{matrix} ] \qquad ( 10 )$$

$${C}_{s} = \frac{{C}_{m}}{1 + \frac{{k}_{s}}{{k}_{c}}} \qquad ( 11 )$$

$${D}_{ei} = {α}_{os} {D}_{m} + {λ}_{i} \vert {v}_{l} \vert {d}_{h} \qquad ( 12 )$$

Where, Cₘ—Acidizing fluid concentration in matrix pores, in mol/m³; Dₑₓ—Effective diffusion tensor in the x direction, in m²/s; D_{ey}—Effective diffusion tensor in the y direction, in m²/s; kₛ—Reaction velocity constant, in m/s; Cₛ—Acidizing fluid concentration at the pore wall, in mol/m³; aᵥ—Rock specific surface area of reservoir matrix, in m²/m³; Dₑᵢ—Effective diffusion tensor in the i direction, in m²/s; αₒₛ, λᵢ—Pore structure constant, and αₒₛ=1, λₓ≈0.5 and λ_{y}≈1 for spherical filling medium; Dₘ—Molecular diffusion coefficient, in m²/s; dₕ—Hydraulic diameter of tubular pore, in m. The calculation model of matrix porosity and permeability changes during acid-rock reaction is as follows:

$$\frac{\partial {ϕ}_{m}}{\partial t} = \frac{{k}_{s} {C}_{s} β {a}_{v}}{{ρ}_{r}} \qquad ( 13 )$$

$$\frac{{k}_{m}}{{k}_{m 0}} = \frac{{ϕ}_{m}}{{ϕ}_{m 0}} {( \frac{{ϕ}_{m} ( 1 - {ϕ}_{m 0} )}{{ϕ}_{m 0} ( 1 - {ϕ}_{m} )} )}^{2 γ} \qquad ( 14 )$$

$$\frac{{a}_{v}}{{a}_{v 0}} = \frac{{ϕ}_{m}}{{{ϕ}_{m 0} ( \frac{{k}_{m} {ϕ}_{m 0}}{{k}_{m 0} {ϕ}_{m}} )}^{1 / 2}} \qquad \text{(15)}$$

Where, kₘ₀—Initial permeability of reservoir matrix, in mD; ϕₘ₀—Initial porosity of reservoir matrix; γ—Parameter related to pore structure; aᵥ₀—Initial rock specific surface area of reservoir matrix, in m²/m³.

(3) Initial conditions for gas reservoir seepage:

P_{mg}(i,j,t)|ₜ₌₀ (16)

Where, P_{mg}(i,j,t)—Gas pressure in the reservoir matrix at the coordinates of positions i and j in the grid at time t, in MPa; P₀—Original formation pressure of gas reservoir, in MPa.

(4) Boundary conditions for fracture propagation:

$$\{ \begin{matrix}W ( x , t ) = 0 & x > {x}_{L = 1} + {\sum }_{L = 1}^{{n}_{f , t}} {ξ}_{L} Or x < {x}_{L = 1} \\ \frac{{\partial }^{2} {W ( x , t )}^{4}}{\partial x} = \frac{256 {Q}_{int} μ ( 1 - v )}{π G} & x = 0\end{matrix} \qquad ( 17 )$$

$${P}_{f L = 1 , t} = {P}_{int} \qquad ( 18 )$$

Where, Qᵢₙₜ—Injection displacement of acid fracturing, in m³/min; G—Volume modulus of reservoir rock sample, in MPa; x_{L=1}—Rectangular coordinates of the first acid etched fracture unit; n_{f,t}—Total number of acid etched fracture units at time t; ξ_{L}—length of the L^{th} acid etched fracture unit, in m; P_{fL=1,t}—Fluid pressure in the acid etched fracture unit in Section 1 at time t, in MPa; Pᵢₙₜ—Downhole pressure during acid fracturing, in MPa.

(5) Boundary conditions for gas reservoir matrix seepage:

$$\{ \begin{matrix}{\frac{\partial {P}_{mg}}{\partial x} \vert}_{x = 0 , {L}_{x}} = 0 \\ {\frac{\partial {P}_{mg}}{\partial y} \vert}_{y = 0 , {L}_{y}} = 0\end{matrix} \& \{ \begin{matrix}{\frac{\partial {P}_{mw}}{\partial x} \vert}_{x = 0 , {L}_{x}} = 0 \\ {\frac{\partial {P}_{mw}}{\partial y} \vert}_{y = 0 , {L}_{y}} = 0\end{matrix} \qquad ( 19 )$$

Where, Lₓ, L_{y}—Length and width of reservoir, in m;

(6) Boundary conditions and initial conditions for acidizing fluid migration reaction model:

$$\{ \begin{matrix}{C}_{f} ( 0 , t ) = {C}_{0 , t} \\ {C}_{f} ( {x}_{L} , t ) = {C}_{0 , t} \\ {C}_{f} ( {L}_{f} , t ) = 0 \\ {C}_{m , t = 0} = 0 \\ {C}_{s , t = 0} = 0\end{matrix} \begin{matrix} \\ 0 < {x}_{L} < {L}_{f} \\ \\ \\ \end{matrix} \qquad ( 20 )$$

Where, C_{f}(0,t)—Acidizing fluid concentration in initial artificial fracture unit at the acid fracturing time t, in mol/m³; C_{f}(x_{L},t)—Acidizing fluid concentration in artificial fracture unit corresponding to the horizontal coordinate x_{L} at time t, in mol/m³; C_{f}(L_{f},t)—Acidizing fluid concentration at the artificial fracture tip at time t, in mol/m³; C_{m,t=0}—Acidizing fluid concentration in the pore at the initial acid fracturing time, in mol/m³; C_{s,t=0}—Acidizing fluid concentration at the pore wall at the initial acid fracturing time, in mol/m³; L_{f}—Horizontal coordinate corresponding to the tip of artificial fracture unit at time t; C_{0,t}—Acidizing fluid concentration of construction fluid at time t, in mol/m³.

Step 3: On the basis of the structured reservoir grid, conducting numerical simulation according to the fracture propagation model, and working out the seepage parameters at a certain moment during acid fracturing;

In a specific embodiment, Newton iteration method for solving nonlinear equations was used to solve the fracture propagation model, and the seepage parameters at a certain time was obtained, specifically including the width W_{L,t}, fluid pressure P_{fL,t} and porosity ϕ_{f}(i,j,t) of acid etched fracture unit and the porosity ϕₘ(i,j,t), gas pressure P_{mg}(i,j,t) and liquid saturation S_{mw}(i,j,t) of matrix grid, wherein the fracture width at the acid etched fracture is defined as W_{L=nf,t}.

Step 4: Determining whether the fracture propagates at a given time according to the acid etched fracture propagation criterion: if there is no propagation, the total number n_{f} of fracture units remains unchanged; if there is propagation, the total number of fracture units is n_{f}=n_{f}+1; the below is the criterion for determining acid etched fracture propagation:
When the stress intensity factor K_{If,t} at fracture tip is less than or equal to the fracture toughness K_{IC} of reservoir rock, the fracture will propagate;
When the stress intensity factor K_{If,t} at fracture tip is greater than the fracture toughness K_{IC} of reservoir rock, the fracture will not propagate.

In a specific embodiment, the stress intensity factor K₁,t at fracture tip is calculated by the following equation:

$$\\ \begin{matrix}{K}_{If , t} = \frac{0.806 E \sqrt{π} {W}_{L = {n}_{f} , t}}{4 ( 1 - {v}^{2} ) \sqrt{2 Δ x}} & ( 21 )\end{matrix}$$

Where, K_{If,t}—Stress intensity factor at fracture tip at time t, in MPa·m^{1/2}; E—Young's modulus of reservoir rock sample, in MPa; W_{L=nf,t}—Average width of structured reservoir grid, in m; v—Poisson's ratio of reservoir rock sample; Δx—Width of artificial fracture tip at time t, in m.

The fracture toughness K_{IC} of reservoir rock is calculated by the following equation:

$${K}_{IC} = 0.3172 {ρ}_{r} + \frac{0.0457}{{V}_{c}} + 0.2131 ln ( DT ) \times 0.5041 \qquad ( 22 )$$

Where, K_{IC}—Type I fracture toughness of reservoir rock, in MPa·m^{1/2}; ρᵣ—Rock density, in kg/m³; Vc—Average shaliness of reservoir rocks, in %; DT—Average interval transit time of the reservoir, in μs/m.

It should be noted that the stress intensity factor at fracture tip and the fracture toughness of reservoir rock can also be calculated by other methods in the prior art in addition to the calculation method in the above embodiment.

Step 5: Taking the seepage parameters obtained in Step 3 and the total number of fracture units obtained in Step 4 as the initial conditions for the next time, and repeating Steps 3 to 5 until the completion of acid fracturing to obtain the seepage parameters at the end of acid fracturing; the seepage parameters at the end of acid fracturing include the total number n_{f,tend} of artificial fracture units, the width W_{L,tend} of each fracture unit, the fluid pressure P_{fL,tend} in each fracture unit, the porosity ϕₘ(i,j,t_{end}) of each fracture unit, the half length

$${\sum }_{L = 1}^{{n}_{f , {t}_{end}}} {ξ}_{L}$$

of artificial fracture, the gas pressure P_{mg}(i,j,t_{end}) in each matrix grid, the porosity ϕ_{f}(i,j,t_{end}) of each matrix grid, and the liquid saturation S_{mw}(i,j,t_{end}) of each matrix grid.

Step 6: Establishing a gas well production model, and calculating the pore distribution and liquid saturation distribution of the reservoir in gas well production according to the gas well production model; the gas well production model includes:

(1) Differential equation of gas-water seepage in gas reservoir:

$$\frac{\partial }{\partial x} ( κ \frac{{k}_{f} {k}_{frw}}{{μ}_{w} {B}_{w}} \frac{\partial {P}_{f}}{\partial x} ) + \frac{{q}_{fw}}{{V}_{f}} + {δ}_{m} \frac{{Q}_{mw}}{{V}_{f}} = \frac{\partial }{\partial {t}_{p}} ( \frac{{ϕ}_{f} {S}_{fw}}{{B}_{w}} ) \qquad ( 23 )$$

$$\frac{\partial }{\partial x} ( κ \frac{{k}_{f} {k}_{frg}}{{μ}_{g} {B}_{g}} \frac{\partial {P}_{f}}{\partial x} ) + \frac{{q}_{fg}}{{V}_{f}} + {δ}_{m} \frac{{Q}_{mg}}{{V}_{f}} = \frac{\partial }{\partial {t}_{p}} ( \frac{{ϕ}_{f} ( 1 - {S}_{fw} )}{{B}_{g}} ) \qquad ( 24 )$$

$$∇ ( β \frac{{k}_{m} {k}_{mrw}}{{μ}_{w} {B}_{w}} ∇ {P}_{mw} ) - {δ}_{m} \frac{{Q}_{mw}}{{V}_{b}} = \frac{\partial }{\partial {t}_{p}} ( \frac{{ϕ}_{m} {S}_{mw}}{{B}_{w}} ) \qquad ( 25 )$$

$$∇ ( β \frac{{k}_{m} {k}_{mrg}}{{μ}_{g} {B}_{g}} ∇ {P}_{mg} ) - {δ}_{m} \frac{{Q}_{mg}}{{V}_{b}} = \frac{\partial }{\partial {t}_{p}} ( \frac{{ϕ}_{m} ( 1 - {S}_{mw} )}{{B}_{g}} ) \qquad ( 26 )$$

$${Q}_{mw} = \frac{2 {k}_{m} {k}_{mw} \cdot {ξ}_{L} H}{{μ}_{w} \overline{d}} ( {P}_{mw} - {P}_{f} ) \qquad ( 27 )$$

$${Q}_{mg} = \frac{2 {k}_{m} {k}_{mg} \cdot {ξ}_{L} H}{{μ}_{g} \overline{d}} ( {P}_{mg} - {P}_{f} ) \qquad \text{(28)}$$

Where, k_{f}—Permeability of acid etched fracture, in mD; k_{fw}, k_{frg}—Relative permeability of liquid and gas in acid etched fracture; P_{f}—Pressure in artificial fracture, in MPa; q_{fw}, q_{fg}—Source and sink terms of liquid and gas in acid etched fracture, in m³/s; Q_{mw}, Q_{mg}—Liquid flow and gas flow between the main fracture and the matrix during gas well production, in m³/s; S_{fw}—Liquid saturation in acid etched fracture; tₚ—Production time of gas well, in s; ∇—Gradient operator.

(2) Initial conditions:

Initial pressure distribution:

$$\{ \begin{matrix}{P}_{fg L , {t}_{p} = 0} = {P}_{fw L , {t}_{p} = 0} = {P}_{f L , {t}_{p} = 0} = {P}_{f L , {t}_{end}} \\ {{P}_{mg} ( i , j , {t}_{p} ) {\vert}_{{t}_{p} = 0} = {P}_{mg} ( i , j , t ) \vert}_{t = {t}_{end}} \\ {{P}_{mw} ( i , j , {t}_{p} ) {\vert}_{{t}_{p} = 0} = {P}_{mw} ( i , j , t ) \vert}_{t = {t}_{end}}\end{matrix} \qquad ( 29 )$$

Where, P_{fg L,tp=0}—Initial gas pressure distribution of acid etched fracture in gas well production simulation, in MPa; P_{fwL,tp=0}—Initial liquid pressure distribution of acid etched fracture in gas well production simulation, in MPa; P_{fL,tp=0}—Initial pressure distribution of acid etched fracture in gas well production simulation, in MPa; P_{fL,tend}—Pressure distribution of artificial fracture at the end of acid fracturing, in MPa; P_{mg}(i,j,tₚ)|tₚ₌₀—Initial gas pressure distribution of reservoir matrix in gas well production simulation, in MPa; P_{mg}(i,j,t)|_{t=tend}—Pressure distribution in artificial fracture at the end of acid fracturing, in MPa; P_{mw}(i,j,tₚ)|ₜₚ₌₀—Initial liquid pressure distribution of reservoir matrix in gas well production simulation, in MPa; P_{mw}(i,j,t)_{|t=tend}—Liquid pressure distribution in artificial fracture at the end of acid fracturing, in MPa.

Initial saturation distribution:

$$\{ \begin{matrix}{{S}_{fw} ( L , {t}_{p} ) \vert}_{{t}_{p} = 0} = 1 \\ {{S}_{mw} ( i , j , {t}_{p} ) {\vert}_{{t}_{p} = 0} = {S}_{mw} ( i , j , t ) \vert}_{t = {t}_{end}}\end{matrix} \qquad ( 30 )$$

Where, S_{fw}(L,tₚ)|ₜₚ₌₀—Initial liquid saturation of acid etched fracture in gas well production simulation; S_{mw}(i,j,tₚ)|ₜₚ₌₀—Initial liquid saturation of reservoir matrix in gas well production simulation; S_{mw}(i,j,t)|_{t=tend}—Liquid saturation of reservoir matrix at the end of acid fracturing.

(3) Internal boundary conditions:

P_{w}(x_{w},y_{w},tₚ)=P_{wf}(tₚ) (31)

Where, P_{w}(x_{w}, y_{w}, tₚ)—Liquid pressure of well-corresponding grid at the simulated time tₚ of gas well production, in MPa; P_{wf}(tₚ)—Bottom hole flowing pressure at production time tₚ, in MPa;

(4) External boundary conditions:

$$\{ \begin{matrix}{\frac{\partial {P}_{mg} ( i , j , {t}_{p} )}{\partial x} \vert}_{x = 0 , {L}_{x}} = 0 \\ {\frac{\partial {P}_{mg} ( i , j , {t}_{p} )}{\partial y} \vert}_{y = 0 , {L}_{y}} = 0\end{matrix} \& \{ \begin{matrix}{\frac{\partial {P}_{mw} ( i , j , {t}_{p} )}{\partial x} \vert}_{x = 0 , {L}_{x}} = 0 \\ {\frac{\partial {P}_{mw} ( i , j , {t}_{p} )}{\partial y} \vert}_{y = 0 , {L}_{y}} = 0\end{matrix} . \qquad ( 32 )$$

Acidized wormholes will change the porosity and permeability of the matrix grid, and then affect the seepage pattern. The gas well production model described in the present invention is built by an embedded discrete fracture model only considering the acid etched fracture, the matrix, and the fluid seepage between acid etched fracture and matrix.

Specifically applying the gas well production model to calculate the pore distribution and fluid saturation distribution of the reservoir during gas well production, the following parameters are taken as the initial parameters of gas well production model: the pressure distribution of each phase of the acid etched fracture unit, the saturation distribution of each phase of the acid etched fracture unit, the pressure distribution of each phase of the matrix grid and the saturation distribution of each phase of the matrix grid at the end of acid fracturing operation. With finite difference discretization and programming, the following parameters can be worked out: the porosity ϕ(i,j,tₚ) and liquid saturation S_{fw}(L,tₚ) of each etched fracture unit in the reservoir, and the porosity ϕₘ(i,j,tₚ) and liquid saturation S_{mw}(L,tₚ) of each matrix grid at any instant in production. It should be noted that the solution method of the gas well production model is in the prior art, and the specific steps will not be described herein.

Step 7: Calculating the cumulative production of the gas well according to the results obtained in Steps 5 and 6; the cumulative production of the gas well is calculated by the following equation:

$$Q = {\sum }_{i = 1}^{{n}_{i}} {\sum }_{j = 1}^{{n}_{j}} ( {x}_{i , j} \cdot {y}_{i , j} \cdot H ) ( {ϕ}_{m} ( i , j , {t}_{p} ) \cdot {S}_{mw} ( i , j , {t}_{p} ) - {ϕ}_{m} ( i , j , {t}_{end} ) {S}_{mw} ( i , j , {t}_{end} ) ) + {\sum }_{L = 1}^{{n}_{f , {t}_{end}}} ( {ξ}_{L} \cdot {W}_{L , {t}_{end}} \cdot H ) ( {ϕ}_{f} ( L , {t}_{end} ) {S}_{fw} ( L , {t}_{end} ) - {ϕ}_{f} ( L , {t}_{p} ) {S}_{fw} ( L , {t}_{p} ) ) \qquad ( 33 )$$

Where, Q—Cumulative production of gas well at time tₚ, in m³; nᵢ, nⱼ—Total number of grids in x and y directions in the structured reservoir grid; x_{i,j}, y_{i,j}—Length and width of matrix grid at positions i and j, in m; #m(i,j,tₚ)—Porosity of matrix grid at positions i and j at time tₚ; S_{mw}(i,j,tₚ) Liquid saturation of matrix grid at positions i and j at time tₚ; +m(i,j,t_{end})—Porosity of matrix grid at positions i and j at time tₚ; S_{mw}(i,j,t_{end})—Liquid saturation of matrix grid at positions i and j at time tₚ; n_{f,tend}—Total number of acid etched fracture units at time t_{end}; W_{L,tend}—Width of acid etched fracture unit in Section L at time t_{end}, in m; ϕ^{f}(i,j,t_{end})—Porosity of acid etched fracture unit in Section L at time t_{end}; S_{fw}(L,t_{end})—Liquid saturation of acid etched fracture unit in Section L at time t_{end}; ϕ^{f}(L,tₚ)—Porosity of acid etched fracture unit in Section L at time tₚ; S_{fw}(L,tₚ)—Liquid saturation of acid etched fracture unit in Section L at time tₚ.

Step 8: Calculating the multiple proportion of cumulative production increase of the construction plan according to the cumulative production of the gas well; the greater the multiple proportion, the better the acid fracturing effect; the multiple proportion of cumulative production increase is calculated by the following equation:

$$S = \frac{{Q}_{T}}{{Q}_{0 , T}} \qquad ( 34 )$$

Where, S—Multiple proportion of cumulative production increase; Q_{T}—Simulated cumulative production of the gas well at time T after acid fracturing, in m³; T—Time when the daily gas production after acid fracturing is equal to the daily gas production before acid fracturing, in d; Q_{0,T}—Estimated cumulative production of the gas well at T without acid-fracturing stimulation, in m³.

It should be noted that gas-water flow is considered in the establishment of each model in the above embodiment and the models are applicable to evaluating the acid fracturing effect of the gas reservoir. The present invention can also adopt the same idea for establishing relevant models of the reservoir based on oil-water flow, so as to evaluate the acid fracturing effect of the reservoir.

In a specific embodiment, in a study case of Well X in a marine carbonate gas reservoir in eastern Sichuan, the present invention was applied to evaluate the acid fracturing effect of the well.

The reservoir depth of Well X is 4,479.5 to 4,502 m, and it is mainly composed of crystal powder dolomite, developed with intergranular pores and dissolved pores; the porosity ranges from 1.6 to 7.4%, 5.1% on average; the permeability ranges from 0.53 mD to 0.74 mD, 0.65 mD on average; the gas saturation ranges 370.36% to 480.59%, 450.52% on average; the temperature is 100.3° C. at the well depth of 4,488.75 m (vertical depth of 4,416.4 m) in the middle of reservoir, and the formation pressure is 40.6 MPa. After the conventional acid-frac stimulation in the early stage of development, the length of acid etched fractures was short, the conductivity was low, the maximum daily production of a single well was 12.27×10⁴ m³/d during well testing, and the average daily production was 10.26×10⁴ m³/d in the first week. It is planned to conduct deep acid-frac stimulation on the reservoir where Well X is located to increase the production of a single well. The working medium is composed of 100 m³ slick water, 180 m³ gelled acid and 140 m³ diverting acid, with the displacement of 4 m³/min, 3 m³/min and 3 m³/min, respectively.

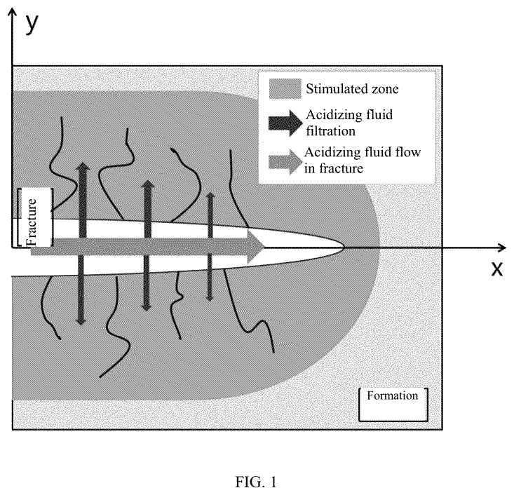

The present invention and the conventional numerical method (numerical method in Numerical Simulation of Productivity of Fractured Gas Well with Start-up Pressure Gradient Considered) are used to simulate acid etched fracture propagation, acidizing fluid flow reaction, acidizing fluid filtration and gas-water seepage in the stimulated zone of Well X with and without consideration of “stimulated zone”. The deep acid fracturing of carbonate reservoir considering the “stimulated zone” is shown in FIG. 1. When simulating the acid fracturing and production of Well X, it was necessary to first establish a structured reservoir grid and initial artificial fractures; then, according to the initial and boundary conditions in (16) to (20), equations (1) to (5) were used to calculate the width and intra-fracture pressure of artificial fracture at a certain time during acid fracturing, and the permeability, porosity, gas pressure and water content in the stimulated zone formed by acidizing fluid filtration were calculated by equations (6) to (15); next, the stress intensity factor K_{If,t} at fracture tip and the fracture toughness K_{IC} of reservoir rock were calculated by equations (21) and (22), and the fracture propagation was determined according to the acid etched fracture propagation criterion; finally, the calculation results at that time were taken as the initial conditions for the next time, and the calculation and determination were repeated until the completion of acid fracturing to obtain the seepage parameters at the end of acid fracturing; the seepage parameters at the end of acid fracturing include the total number n_{f,tend} of artificial fracture units, the width W_{L,tend} of each fracture unit, the fluid pressure P_{fL,tend} in each fracture unit, the porosity ϕₘ(i,j,t_{end}) of each fracture unit, the half length

$${\sum }_{L = 1}^{{n}_{f , {t}_{end}}} {ξ}_{L}$$

of artificial fracture, the gas pressure P_{mg}(i,j,t_{end}) in each matrix grid, the porosity ϕ_{f}(i,j,t_{end}) of each matrix grid, and the liquid saturation S_{mw}(i,j,t_{end}) of each matrix grid; These parameters were taken as the initial conditions of gas well production, the porosity distribution and liquid saturation distribution of gas well at different production times were calculated by equations (23) to (28) under the initial conditions and boundary conditions shown in (29) to (32), and then equations (33) to (34) were used to work out the simulated cumulative production at time T of gas well production and the multiple proportion of cumulative production increase after deep acid fracturing.

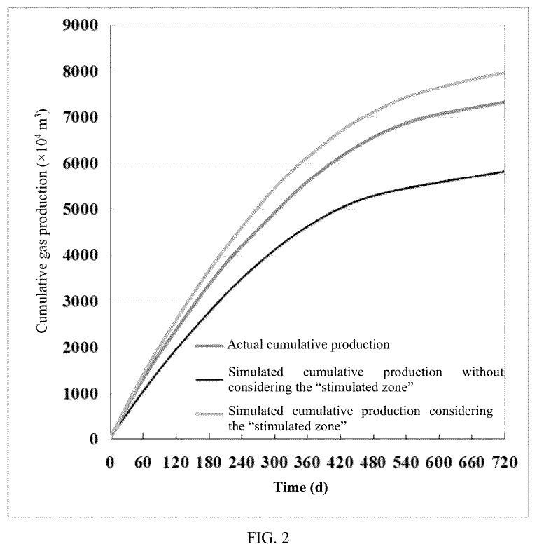

The simulated cumulative production result of this embodiment is shown in FIG. 2. It can be seen from FIG. 2 that the maximum daily production of Well X after stimulation is 23.16×10⁴ m³/d, and the cumulative production after 720 days is 7.319×10⁷ m³. Before stimulation, Well X is simulated to product for 720 days, and the simulated cumulative production is 7.952×10⁷ m³ and 5.806×10⁷ m³ with or without consideration of the “stimulated zone”, respectively. Therefore, with consideration of the seepage pattern improvement and stimulation effect by the acid-frac “stimulated zone”, the present invention can predict the cumulative production of single well in a certain acid fracturing plan more accurately, and effectively improve the accuracy of the evaluation results of acid fracturing effect, which severs the purpose of optimizing the acid fracturing plan, and significantly guiding the development of carbonate reservoir with reduced cost and enhanced efficiency. It is a significant improvement over the prior art.

The above are only the preferred embodiments, which are not intended to limit the present invention in any form. Although the present invention has been disclosed as above with preferred embodiments, it is not intended to limit the present invention. Those skilled in the art, within the scope of the technical solution of the present invention, can use the disclosed technical content to make a few changes or modify the equivalent embodiment with equivalent changes. Within the scope of the technical solution of the present invention, any simple modification, equivalent change and modification made to the above embodiments according to the technical essence of the present invention are still regarded as a part of the technical solution of the present invention.

1. A deep acid-frac stimulation method based on an evaluation for acid fracturing effect, comprising the following steps:
Step 1: collecting a geological exploration data of a target reservoir, dividing the target reservoir into a nᵢ×nⱼ structured grid to establishing a structured reservoir grid, and adding an initial artificial fractures to the structured reservoir grid, wherein the initial artificial fractures are divided into multiple fracture units by the structured reservoir grid, the multiple fracture units are numbered by consecutive positive integers, a length of each fracture unit of the multiple fracture units is denoted as ξ_{L} and a total number of fracture units as n_{f};
Step 2: Establishing a fracture propagation model considering an acid-frac stimulated zone formed by a dissolution of acid fluid filtering along a acid etched fracture in the target reservoir, wherein the fracture propagation model comprises:
(1) a first calculation model considering fracture width and intra-fracture pressure in the acid-frac stimulated zone:
$$W ( x , t ) = w ( x ) + \overline{{w}_{e} ( t )} \qquad ( 1 )$$
$$\frac{π E}{512 μ ( 1 - {𝓋}^{2} )} \frac{{\partial }^{2} {w}^{4} ( x )}{\partial {x}^{2}} - 2 {v}_{l} H = \frac{π H}{4} \frac{\partial w ( x )}{\partial t} \qquad ( 2 )$$
$${v}_{l} = \frac{{k}_{m f}}{μ \overline{d}} [ \frac{w ( x ) E}{2 ( 1 - {𝓋}^{2} ) H} + {σ}_{n} - {P}_{m} ( x ) ] \qquad ( 3 )$$
$$\frac{β}{{ρ}_{r} ( 1 - {ϕ}_{m} )} ( 2 η {v}_{l} {C}_{f} + 2 {k}_{c} {C}_{f} ) = \frac{\partial \overline{{w}_{e} ( t )}}{\partial t} \qquad ( 4 )$$
$${P}_{f} ( x , t ) = \frac{W ( x , t ) E}{2 ( 1 - {𝓋}^{2} ) H} + {σ}_{n} \qquad ( 5 )$$
Where, W(x,t)—Width of a first acid etched fracture at any time and at any position during acid fracturing, in m; w(x)—Width of a second acid etched fracture, in m; w̅ₑ̅(̅t̅)̅—Average width of acid etched fracture at acid fracturing time, in m; E—Young's modulus of reservoir rock sample, in MPa; μ—Viscosity of acidizing fluid, in mPa·s; v—Poisson's ratio of reservoir rock sample; x—Position of the structured reservoir grid along an X axis; vₗ—Filtration rate of acidizing fluid, in m/s; H—Height of acid etched fracture X axis, in m; t—Acid fracturing time, in s; k_{mf}—Average permeability between acid etched fracture and surrounding matrix, in mD; d̅—Distance from the acid etched fracture to a center point of a matrix grid where it is located, in m; σₙ Minimum horizontal principal stress, in MPa; Pₘ(x)—Fluid pressure of the matrix around acid etched fracture, in MPa; β—Rock dissolution capacity of acidizing fluid, defined as a mass of rock dissolved by acidizing fluid per mole, in kg/mol; ρᵣ—Rock density, in kg/m³; ϕₘ—a Porosity of a reservoir matrix, in %; η—Mass fraction of acidizing fluid in filtration that is involved in etching fracture wall; C_{f}—Acidizing fluid concentration in the acid etched fracture, in mol/m³; k_{c}—Mass transfer coefficient, in m/s; P_{f}(x,t)—Fluid pressure in the acid etched fracture at any time and at any position in a fracturing process, in MPa;
(2) a Matrix seepage model considering acid-frac stimulated zone during acid fracturing of gas reservoir:
$$\frac{\partial }{\partial x} ( κ \frac{{k}_{f w}}{μ B} \frac{\partial {P}_{f} ( x , t )}{\partial x} ) - {δ}_{m} \frac{{v}_{l} {A}_{m f}}{{V}_{f}} = \frac{\partial }{\partial t} ( \frac{{ϕ}_{f}}{B} ) \qquad ( 6 )$$
$$\frac{\partial }{\partial x} ( \frac{{k}_{m} {k}_{mrw}}{{μ}_{w} {B}_{w}} \frac{\partial {P}_{mw}}{\partial x} ) + \frac{\partial }{\partial y} ( \frac{{k}_{m} {k}_{mrw}}{{μ}_{w} {B}_{w}} \frac{\partial {P}_{mw}}{\partial y} ) + {δ}_{m} \frac{{v}_{l} {A}_{m f}}{{V}_{b}} = \frac{\partial }{\partial t} ( \frac{{ϕ}_{m} {S}_{mw}}{{B}_{w}} ) \qquad ( 7 )$$
$$\frac{\partial }{\partial x} ( \frac{{k}_{m} {k}_{m r g}}{{μ}_{g} {B}_{g}} \frac{\partial {P}_{m g}}{\partial x} ) + \frac{\partial }{\partial y} ( \frac{{k}_{m} {k}_{m r g}}{{μ}_{g} {B}_{g}} \frac{\partial {P}_{m g}}{\partial y} ) = \frac{\partial }{\partial t} ( \frac{{ϕ}_{m} ( 1 - {S}_{m w} )}{{B}_{g}} ) \qquad ( 8 )$$
$${P}_{m c} = {P}_{m g} - {P}_{m w} \qquad ( 9 )$$
Where, κ—Unit conversion coefficient, in 10⁻³; k_{fw}—Effective liquid permeability of acid etched fracture, in mD; B—Volume coefficient of acidizing fluid; δₘ—Judgment parameter, specifically δₘ=1 if there is fractures across the reservoir matrix grid and δₘ=0 if there is no fracture across the reservoir matrix grid; A_{mf}—Contact area between fracture and matrix, in m²; V_{f} Volume of acid etched fracture unit, in m³; ϕ_{f}—Porosity of acid etched fracture; kₘ—Reservoir matrix permeability, in mD; k_{mrw}—Relative liquid permeability of the reservoir matrix; k_{mrg}—Relative gas permeability of the reservoir matrix; w Liquid viscosity in the reservoir matrix, in mPa·s; μg—Gas viscosity in the reservoir matrix, in mPa·s; B_{w}—Bolume coefficient of liquid in the reservoir matrix; B_{g}—Volume coefficient of gas in the reservoir matrix; P_{mw}, P_{mg}—Liquid pressure and gas pressure in the reservoir matrix, in MPa; y—Position of the structured reservoir grid along the Y axis; μ_{b}—Volume of reservoir matrix unit, in m³; S_{mw}—Liquid saturation in the reservoir matrix; P_{mc}—Capillary pressure in the reservoir matrix, in MPa;
a second calculation model of acidizing fluid concentration distribution in reservoir matrix grid is as follows:
$$\frac{\partial }{\partial t} ( {ϕ}_{m} {C}_{m} ) = [ \begin{matrix}- \frac{\partial }{\partial x} ( {C}_{m} \frac{{k}_{m} {k}_{m r w}}{{μ}_{w}} \frac{\partial {P}_{m w}}{\partial x} ) - \frac{\partial }{\partial y} ( {C}_{m} \frac{{k}_{m} {k}_{m r w}}{{μ}_{w}} \frac{\partial {P}_{m w}}{\partial x} ) \\ + \frac{\partial }{\partial x} ( {ϕ}_{m} {D}_{ex} \frac{\partial {C}_{m}}{\partial x} ) + \frac{\partial }{\partial y} ( {ϕ}_{m} {D}_{ey} \frac{\partial {C}_{m}}{\partial y} ) \\ + {δ}_{m} \frac{{v}_{l} {A}_{m f} {C}_{f}}{{V}_{b}} - {k}_{s} {C}_{s} {a}_{v}\end{matrix} ] \qquad ( 10 )$$
$${C}_{s} = \frac{{C}_{m}}{1 + \frac{{k}_{s}}{{k}_{c}}} \qquad ( 11 )$$
$${D}_{e i} = {α}_{o s} {D}_{m} + {λ}_{i} \vert {v}_{l} \vert {d}_{h} \qquad ( 12 )$$
Where, Cₘ—Acidizing fluid concentration in matrix pores, in mol/m³; Dₑₓ—Effective diffusion tensor in an x direction, in m²/s; D_{ey}—Effective diffusion tensor in a y direction, in m²/s; kₛ—Reaction velocity constant, in m/s; Cₛ—Acidizing fluid concentration at a pore wall, in mol/m³; aᵥ—Rock specific surface area of reservoir matrix, in m²/m³; Dₑᵢ—Effective diffusion tensor in an i direction, in m²/s; αₒₛ,λᵢ—Pore structure constant, and αₒₛ=1, λ≈0.5 and χ₇≈1 for spherical filling medium; Dₘ—Molecular diffusion coefficient, in m²/s; dₕ—Hydraulic diameter of tubular pore, in m; a third calculation model of matrix porosity and permeability changes during an acid-rock reaction is as follows:
$$\frac{\partial {ϕ}_{m}}{\partial t} = \frac{{k}_{s} {C}_{s} β {a}_{v}}{{ρ}_{r}} \qquad ( 13 )$$
$$\frac{{k}_{m}}{{k}_{m 0}} = \frac{{ϕ}_{m}}{{ϕ}_{m 0}} {( \frac{{ϕ}_{m} ( 1 - {ϕ}_{m 0} )}{{ϕ}_{m 0} ( 1 - {ϕ}_{m} )} )}^{2 γ} \qquad ( 14 )$$
$$\frac{{a}_{v}}{{a}_{v 0}} = \frac{{ϕ}_{m}}{{{ϕ}_{m 0} ( \frac{{k}_{m} {ϕ}_{m 0}}{{k}_{m 0} {ϕ}_{m}} )}^{1 / 2}} \qquad ( 15 )$$
Where, kₘ₀—Initial permeability of the reservoir matrix, in mD; ϕₘ₀—Initial porosity of the reservoir matrix; γ—Parameter related to pore structure; aᵥ₀—Initial rock specific surface area of the reservoir matrix, in m²/m³;
(3) Initial conditions for gas reservoir seepage:
P_{mg}(i,j,t)|ₜ₌₀ (16)
Where, P_{mg}(i,j,t)—Gas pressure in the reservoir matrix at a coordinates of positions i and j in a grid at time t, in MPa; P₀—Original formation pressure of a gas reservoir, in MPa;
(4) Boundary conditions for fracture propagation:
$$\{ \begin{matrix}W ( x , t ) = 0 & x > {x}_{L = 1} + {\sum }_{L = 1}^{{u}_{f , t}} {ξ}_{L} {o}_{r} x < {x}_{L = 1} \\ \frac{{\partial }^{2} {W ( x , t )}^{4}}{\partial x} = \frac{256 {Q}_{int} μ ( 1 - 𝓋 )}{π G} & x = 0\end{matrix} \qquad ( 17 )$$
$${P}_{fL = 1 , t} = {P}_{int} \qquad ( 18 )$$
Where, Qᵢₙₜ—Injection displacement of acid fracturing, in m³/min; G—Volume modulus of a reservoir rock sample, in MPa; x_{L=1}—Rectangular coordinates of the first acid etched fracture unit; n_{f,t}—Total number of acid etched fracture units at time t; ξ_{L} length of a L^{th} acid etched fracture unit, in m; P_{fL=1,t}—Fluid pressure in the acid etched fracture unit in Section 1 at time t, in MPa; Pᵢₙₜ—Downhole pressure during acid fracturing, in MPa;
(5) Boundary conditions for the gas reservoir matrix seepage:
$$\{ \begin{matrix}\frac{\partial {P}_{m g}}{\partial x} {\vert}_{x = 0 , {L}_{x}} = 0 \\ \frac{\partial {P}_{m g}}{\partial y} {\vert}_{y = 0 , {L}_{y}} = 0\end{matrix} \& \{ \begin{matrix}\frac{\partial {P}_{mw}}{\partial x} {\vert}_{x = 0 , {L}_{x}} = 0 \\ \frac{\partial {P}_{mw}}{\partial y} {\vert}_{y = 0 , {L}_{y}} = 0\end{matrix} \qquad ( 19 )$$
Where, Lₓ, L_{y} Length and width of the gas reservoir, in m;
(6) Boundary conditions and initial conditions of acidizing fluid migration reaction model:
$$\{ \begin{matrix}{C}_{f} ( 0 , t ) = {C}_{0 , t} \\ \begin{matrix}{C}_{f} ( {x}_{L} , t ) = {C}_{0 , t} & 0 < {x}_{L} < {L}_{f}\end{matrix} \\ {C}_{f} ( {L}_{f} , t ) = 0 \\ {C}_{m , t = 0} = 0 \\ {C}_{s , t = 0} = 0\end{matrix} \qquad ( 20 )$$
Where, C_{f}(0,t)—Acidizing fluid concentration in initial artificial fracture unit at an acid fracturing time t, in mol/m³; C_{f}(x_{L},t)—Acidizing fluid concentration in artificial fracture unit corresponding to a horizontal coordinate x_{L} at time t, in mol/m³; C_{f}(L_{f},t)—Acidizing fluid concentration at the artificial fracture tip at time t, in mol/m³; C_{m,t=0}—Acidizing fluid concentration in a pore at the initial acid fracturing time, in mol/m³; C_{s,t=0}—Acidizing fluid concentration at the pore wall at the initial acid fracturing time, in mol/m³; L_{f}—Horizontal coordinate corresponding to a tip of artificial fracture unit at time t; C_{0,t}—Acidizing fluid concentration of construction fluid at time t, in mol/m³;
Step 3: On basis of the structured reservoir grid, conducting numerical simulation of a construction plan according to the fracture propagation model, and working out seepage parameters at a certain moment during acid fracturing;
Step 4: Determining whether a fracture propagates at a given time according to a acid etched fracture propagation criterion: if there is no propagation, a total number n_{f} of fracture units remains unchanged; if there is propagation, the total number of fracture units is n_{f}=n_{f}+1;
Step 5: Taking the seepage parameters obtained in Step 3 and the total number of fracture units obtained in Step 4 as an initial conditions for the next time, and repeating Steps 3 to 5 until a completion of acid fracturing to obtain the seepage parameters at the end of acid fracturing;
Step 6: Establishing a gas well production model, and calculating a pore distribution and a liquid saturation distribution of the reservoir in a gas well production according to the gas well production model;
Step 7: Calculating a cumulative production of the gas well according to a results obtained in Steps 5 and 6;
Step 8: Calculating a multiple proportions of cumulative production increase of the construction plan according to the cumulative production of the gas well; the greater the multiple proportion, the better an acid fracturing effect; and implementing a deep acid-frac stimulation according to the construction plan.

2. The deep acid-frac stimulation method according to claim 1, wherein in Step 1, the establishment of a structured reservoir grid comprises the following sub-steps: collecting the geological exploration data of target reservoir, dividing the reservoir length Lₓ and reservoir width L_{y} into nᵢ and nⱼ segments respectively in an x-y rectangular coordinate system, so the entire reservoir can be divided into a nᵢ×nⱼ structured grid, where x_{i,j} and y_{i,j} represent the length and width of each grid respectively, and the subscripts i and j represent the position of each grid in the reservoir.

3. The deep acid-frac stimulation method according to claim 1, wherein in Step 1, when adding initial artificial fractures to the structured reservoir grid, a propagation direction of initial artificial fracture is designed as the x-axis direction and a propagation length as the total length of N grids, wherein N is an integer greater than or equal to 3.

4. The deep acid-frac stimulation method according to claim 1, wherein in Step 4, the acid etched fracture propagation criterion comprising:
When a stress intensity factor K_{If,t} at fracture tip is less than or equal to a fracture toughness K_{IC} of reservoir rock, the fracture will propagate;
When the stress intensity factor K_{If,t} at fracture tip is greater than the fracture toughness K_{IC} of reservoir rock, the fracture will not propagate.

5. The deep acid-frac stimulation method according to claim 4, wherein the stress intensity factor K_{If,t} at fracture tip is calculated by the following equation:
$${K}_{If , t} = \frac{0.806 E \sqrt{π} {W}_{L = {n}_{f} , t}}{4 ( 1 - {v}^{2} ) \sqrt{2 Δ x}} \qquad ( 21 )$$
Where, K_{If,t}—Stress intensity factor at fracture tip at time t, in MPa·m^{1/2}; E—Young's modulus of reservoir rock sample, in MPa; W_{L=nf,t}—Average width of structured reservoir grid, in m; v—Poisson's ratio of reservoir rock sample; Δx—Width of artificial fracture tip at time t, in m;
The fracture toughness K_{IC} of reservoir rock is calculated by the following equation:
$${K}_{I C} = 0.3172 {ρ}_{r} + \frac{0.0457}{{V}_{c}} + 0.2131 ln ( DT ) \times 0.5041 \qquad ( 22 )$$
Where, K_{IC}—Type I fracture toughness of reservoir rock, in MPa·m^{1/2}; ρᵣ—Rock density, in kg/m³; V_{c}—Average shaliness of reservoir rocks, in %; DT—Average interval transit time of the reservoir, in s/m.

6. The deep acid-frac stimulation method according to claim 1, wherein in Step 6, the gas well production model comprises:
(1) Differential equation of gas-water seepage in gas reservoir:
$$\frac{\partial }{\partial x} ( κ \frac{{k}_{f} {k}_{frw}}{{μ}_{w} {B}_{w}} \frac{\partial {P}_{f}}{\partial x} ) + \frac{{q}_{fw}}{{V}_{f}} + {δ}_{m} \frac{{Q}_{m w}}{{V}_{f}} = \frac{\partial }{\partial {t}_{p}} ( \frac{{ϕ}_{f} {S}_{fw}}{{B}_{w}} ) \qquad ( 23 )$$
$$\frac{\partial }{\partial x} ( κ \frac{{k}_{f} {k}_{f r g}}{{μ}_{g} {B}_{g}} \frac{\partial {P}_{f}}{\partial x} ) + \frac{{q}_{f g}}{{V}_{f}} + {δ}_{m} \frac{{Q}_{m g}}{{V}_{f}} = \frac{\partial }{\partial {t}_{p}} ( \frac{{ϕ}_{f} ( 1 - {S}_{f w} )}{{B}_{g}} ) \qquad ( 24 )$$
$$∇ ( β \frac{{k}_{m} {k}_{mrw}}{{μ}_{w} {B}_{w}} ∇ {P}_{m w} ) - {δ}_{m} \frac{{Q}_{m w}}{{V}_{b}} = \frac{\partial }{\partial {t}_{p}} ( \frac{{ϕ}_{m} {S}_{m w}}{{B}_{w}} ) \qquad ( 25 )$$
$$∇ ( β \frac{{k}_{m} {k}_{m r g}}{{μ}_{g} {B}_{g}} ∇ {P}_{m g} ) - {δ}_{m} \frac{{Q}_{m g}}{{V}_{b}} = \frac{\partial }{\partial {t}_{p}} ( \frac{{ϕ}_{m} ( 1 - {S}_{mw} )}{{B}_{g}} ) \qquad ( 26 )$$
$${Q}_{m w} = \frac{2 {k}_{m} {k}_{m w} \cdot {ξ}_{L} H}{{μ}_{w} \overline{d}} ( {P}_{m w} - {P}_{f} ) \qquad ( 27 )$$
$${Q}_{m g} = \frac{2 {k}_{m} {k}_{m g} \cdot {ξ}_{L} H}{{μ}_{g} \overline{d}} ( {P}_{m g} - {P}_{f} ) \qquad ( 28 )$$
Where, k_{f}—Permeability of acid etched fracture, in mD; k_{frw}, k_{frg}—Relative permeability of liquid and gas in acid etched fracture; P_{f}—Pressure in artificial fracture, in MPa; q_{fw}, q_{fg}—Source and sink terms of liquid and gas in acid etched fracture, in m³/s; Q_{mw}, Q_{mg}—Liquid flow and gas flow between the main fracture and the matrix during gas well production, in m³/s; S_{fw}—Liquid saturation in acid etched fracture; tₚ—Production time of gas well, in s; ∇—Gradient operator;
(2) Initial conditions:
Initial pressure distribution:
$$\{ \begin{matrix}{P}_{fgL , {t}_{p} = 0} = {P}_{fwL , {t}_{p} = 0} = {P}_{fL , {t}_{p} = 0} = {P}_{fL , {t}_{e n d}} \\ {P}_{m g} ( i , j , {t}_{p} ) {\vert}_{{t}_{p} = 0} = {P}_{m g} ( i , j , t ) {\vert}_{t = {t}_{e n d}} \\ {P}_{m w} ( i , j , {t}_{p} ) {\vert}_{{t}_{p} = 0} = {P}_{m w} ( i , j , t ) {\vert}_{t = {t}_{e n d}}\end{matrix} \qquad ( 29 )$$
Where, P_{fgL,tp=0}—Initial gas pressure distribution of acid etched fracture in gas well production simulation, in MPa; P_{fwL,tp=0}—Initial liquid pressure distribution of acid etched fracture in gas well production simulation, in MPa; P_{fL,t=0}—Initial pressure distribution of acid etched fracture in gas well production simulation, in MPa; P_{fL,tend}—Pressure distribution of artificial fracture at the end of acid fracturing, in MPa; P_{mg}(i,j,tₚ)|ₜₚ₌₀—Initial gas pressure distribution of reservoir matrix in gas well production simulation, in MPa; P_{mg}(i,j,t)|_{t=tend}—Pressure distribution in artificial fracture at the end of acid fracturing, in MPa; P_{mw}(i,j,tₚ)|ₜₚ₌₀—Initial liquid pressure distribution of reservoir matrix in gas well production simulation, in MPa; P_{mw}(i,j,t)|_{t=tend} Liquid pressure distribution in artificial fracture at the end of acid fracturing, in MPa;
Initial saturation distribution:
$$\{ \begin{matrix}{S}_{f w} ( L , {t}_{p} ) {\vert}_{{t}_{p} = 0} = 1 \\ {S}_{m w} ( i , j , {t}_{p} ) {\vert}_{{t}_{p} = 0} = {S}_{m w} ( i , j , t ) {\vert}_{t = {t}_{end}}\end{matrix} \qquad ( 30 )$$
Where, S_{fw}(L,tₚ)|ₜₚ₌₀—Initial liquid saturation of acid etched fracture in gas well production simulation; S_{mw}(i,j,tₚ)|ₜₚ₌₀—Initial liquid saturation of reservoir matrix in gas well production simulation; S_{mw}(i,j,t)|_{t=tend}—Liquid saturation of reservoir matrix at the end of acid fracturing;
(3) Internal boundary conditions:
P_{w}(x_{w},y_{w},tₚ)=P_{wf}(tₚ) (31)
Where, P_{w}(x_{w}, y_{w}, tₚ)—Liquid pressure of well-corresponding grid at the simulated time tₚ of gas well production, in MPa; P_{wf}(tₚ)—Bottom hole flowing pressure at production time tₚ, in MPa;
(4) External boundary conditions:
$$\{ \begin{matrix}\frac{\partial {P}_{m g} ( i , j , {t}_{p} )}{\partial x} {\vert}_{x = 0 , {L}_{x}} = 0 \\ \frac{\partial {P}_{m g} ( i , j , {t}_{p} )}{\partial y} {\vert}_{y = 0 , {L}_{y}} = 0\end{matrix} \& \{ \begin{matrix}\frac{\partial {P}_{m w} ( i , j , {t}_{p} )}{\partial x} {\vert}_{x = 0 , {L}_{x}} = 0 \\ \frac{\partial {P}_{m w} ( i , j , {t}_{p} )}{\partial y} {\vert}_{y = 0 , L y} = 0\end{matrix} \qquad ( 32 )$$

7. The evaluation method for acid fracturing effect based on the theory of acid-frac “stimulated zone” according to claim 6, wherein in Step 7, the cumulative production of the gas well is calculated by the following equation:
$$Q = {\sum }_{i = 1}^{{n}_{i}} {\sum }_{j = 1}^{{n}_{j}} ( {x}_{i , j} \cdot {y}_{i , j} \cdot H ) ( {ϕ}_{m} ( i , j , {t}_{p} ) \cdot {S}_{m w} ( i , j , {t}_{p} ) - {ϕ}_{m} ( i , j , {t}_{e n d} ) {S}_{m w} ( i , j , {t}_{e n d} ) ) + {\sum }_{L = 1}^{{{{n}_{f , {t}_{end}}}_{}}_{}} ( {ξ}_{L} \cdot {W}_{L , {t}_{end}} \cdot H ) ( {ϕ}_{f} ( L , {t}_{e n d} ) {S}_{fw} ( L , {t}_{e n d} ) - {ϕ}_{f} ( L , {t}_{p} ) {S}_{f w} ( L , {t}_{p} ) ) \qquad ( 33 )$$
Where, Q—Cumulative production of gas well at time tₚ, in m³; nᵢ, nⱼ—Total number of grids in x and y directions in the structured reservoir grid; x_{i,j}, y_{i,j}—Length and width of matrix grid at positions i and j, in m; +m(i,j,tₚ)—Porosity of matrix grid at positions i and j at time tₚ; S_{mw}(i,j,tₚ)—Liquid saturation of matrix grid at positions i and j at time tₚ; ϕₘ(i,j,t_{end})—Porosity of matrix grid at positions i and j at time tₚ; S_{mw}(i,j,t_{end})—Liquid saturation of matrix grid at positions i and j at time tₚ; n_{f,tend}—Total number of acid etched fracture units at time t_{end}; W_{L,tend}—Width of acid etched fracture unit in Section L at time tena, in m; #h(i,j,t_{end})—Porosity of acid etched fracture unit in Section L at time t_{end}; S_{fw}(L,t_{end})—Liquid saturation of acid etched fracture unit in Section L at time t_{end}; ϕ^{f}(L,tₚ)—Porosity of acid etched fracture unit in Section L at time tₚ; S_{fw}(L,tₚ)—Liquid saturation of acid etched fracture unit in Section L at time tₚ;
In Step 8, the multiple proportion of cumulative production increase is calculated by the following equation:
$$S = \frac{{Q}_{T}}{{Q}_{0 , T}} \qquad ( 34 )$$
Where, S—Multiple proportion of cumulative production increase; Q_{T}—Simulated cumulative production of the gas well at time T after acid fracturing, in m³; T—Time when the daily gas production after acid fracturing is equal to the daily gas production before acid fracturing, in d; Q_{0,T}—Estimated cumulative production of the gas well at T without acid-fracturing stimulation, in m³.
